(19) United States
(12) Patent Application Publication
(10) Pub. No.: US 2017/0217253 A1
(43) Pub. Date: Aug. 3, 2017

(54) Tire Tread for an Agricultural Vehicle

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Patrick VERVAET, Clermont-Ferrand Cedex 9 (FR); Daniel REY, Clermont-Ferrand Cedex 9 (FR); Gautier LALANCE, Clermont-Ferrand Cedex 9 (FR); Jean-Luc MANGERET, Clermont-Ferrand Cedex 9 (FR)

(21) Appl. No.: 15/304,915

(22) PCT Filed: Apr. 17, 2015
(86) PCT No.: PCT/EP2015/058343

§ 371 Date: Oct. 18, 2016

(30) Foreign Application Priority Data
Apr. 18, 2014 (FR) 1453524

(51) Int. Cl. B60C 11/00; B60C 11/03

(52) U.S. Cl. CPC B60C 11/0058; B60C 11/005; B60C 11/0311; B60C 2200/08; B60C 2011/0025; B60C 2011/0313; B60C 2200/14

(57) ABSTRACT

Tread of a tire for an agricultural vehicle. The tread (2) comprises a first, median portion (21) having an axial width L₁, at least equal to 0.25 times and at most equal to 0.75 times the axial width L, and second and third, lateral portions (22, 23) that respectively extend axially outwards from the first, median portion (21) as far as an axial end (E, E′) and have respective axial widths (L₂, L₃). Each lug portion (311) that is axially contained in the first, median portion (21) and extends radially inwards, from the contact face (6) as far as a first interface (7), over a radial distance D₁ at least equal to 0.5 times and at most equal to 1 time the radial lug height H, includes a first elastomeric compound. Each lug portion (321) that is axially contained in one of the second or third, lateral portions (22, 23) and extends radially inwards, from the contact face (6) as far as a second interface (8), over a radial distance D₂ at least equal to 0.5 times and at most equal to 1 time the radial lug height H, includes a second elastomeric compound.

The present invention relates to a tire for an agricultural vehicle, such as an agricultural tractor or an agri-industrial vehicle.

It relates more particularly to the tread of such a tire, which is intended to come into contact with the ground via a tread surface.

In what follows, the circumferential, axial and radial directions refer respectively to a direction tangential to the tread surface of the tire and oriented in the direction of rotation of the tire, to a direction parallel to the axis of rotation of the tire, and to a direction perpendicular to the axis of rotation of the tire. “Radially inside or, respectively, radially outside” means “closer to or, respectively, further away from the axis of rotation of the tire”. “Axially inside or, respectively, axially outside” means “closer to or, respectively, further away from the equatorial plane of the tire”, the equatorial plane of the tire being the plane that passes through the middle of the tread surface of the tire and is perpendicular to the axis of rotation of the tire.

A tire for an agricultural tractor is intended to run over various types of ground such as the more or less compacted soil of the fields, unmade tracks providing access to the fields, and the tarmac surfaces of roads. Bearing in mind the diversity of use, in the fields and on the road, a tire for an agricultural tractor and, in particular, the tread thereof, needs to offer a performance compromise between traction in the field, resistance to chunking, resistance to wear on road, rolling resistance, and vibrational comfort on the road.

The tread of a tire for an agricultural tractor generally comprises a plurality of lugs. The lugs are elements that are raised with respect to a surface of revolution about the axis of rotation of the tire, known as the bottom surface.

A lug generally has an elongate parallelepipedal overall shape made up of at least one rectilinear or curvilinear portion, and is separated from the adjacent lugs by grooves. A lug may be made up of a succession of rectilinear portions, as described in documents U.S. Pat. No. 3,603,370, U.S. Pat. No. 4,383,567, EP795427 or may have a curvilinear shape, as set out in documents U.S. Pat. No. 4,446,902, EP903249, EP1831034.

In the radial direction, a lug extends from the bottom surface as far as the tread surface, the radial distance between the bottom surface and the tread surface defining the lug height. The radially outer face of the lug, belonging to the tread surface, which comes into contact with the ground as the lug enters the contact patch in which the tire is in contact with the ground, is known as the contact face of the lug.

In the axial direction, a lug extends inwards, towards the equatorial plane of the tire, from an axially outer end face as far as an axially inner end face.

In the circumferential direction, a lug extends, in a preferred direction of rotation of the tire, from a leading face as far as a trailing face. A preferred direction of rotation means the direction of rotation recommended by the manufacturer of the tire for optimum use of the tire. By way of example, in the case of a tread comprising two rows of lugs configured in a V or chevron formation, the tire has a preferred direction of rotation according to the point of the chevrons. The leading face is, by definition, the face of which the radially outer edge face or leading edge face is first to come into contact with the ground when the lug enters the contact patch in which the tire is in contact with the ground, as the tire rotates. The trailing face is, by definition, the face of which the radially outer edge or trailing edge is last to come into contact with the ground when the lug enters the contact patch in which the tire is in contact with the ground, as the tire rotates. In the direction of rotation, the leading face is said to be forward of the trailing face.

A lug usually, but not necessarily, has a mean angle of inclination with respect to the circumferential direction of close to 45°. This is because this mean angle of inclination in particular allows a good compromise between traction in the field and vibrational comfort. Traction in the field is better if the lug is more axial, that is to say if its mean angle of inclination with respect to the circumferential direction is close to 90°, whereas vibrational comfort is better if the lug is more circumferential, that is to say if its mean angle of inclination with respect to the circumferential direction is close to 0°. It is a well-known fact that traction in the field is more greatly determined by the angle of the lug in the shoulder region, and this has led certain tire designers to offer a very curved lug shape, leading to a lug that is substantially axial at the shoulder and substantially circumferential in the middle of the tread.

The tread of a tire for an agricultural tractor generally comprises two rows of lugs as described above. This distribution of lugs which are inclined with respect to the circumferential direction gives the tread a V shape commonly referred to as a chevron pattern. The two rows of lugs exhibit symmetry about the equatorial plane of the tire, usually with a circumferential offset between the two rows of lugs, resulting from one half of the tread being rotated about the axis of the tire with respect to the other half of the tread. Furthermore, the lugs may be continuous or discontinuous and may be circumferentially distributed with a spacing that is either constant or variable.

A currently strong tendency in the definition of agricultural machines of the tractor type is to integrate a dynamic system for managing the internal pressure of the tires into the operation of these machines. This is because agricultural machines of the tractor type generally work in two different operating modes: work on generally loose agricultural ground and road-based or track-based transport on hard ground.

In the case of work on agricultural ground, it is important to inflate the casings to the lowest possible pressure that is compatible with the endurance of the tire. This is because it is known that the higher the internal pressure of the tire, the more the ground will settle as the tractor passes over: this will penalize the agronomic yield of the subsequent crops. In addition, the resistance to the progress of the vehicle will be lower, the lower the pressure of the tire is, on account of the reduction in ruts.

In the case of road-based or track-based transport on hard ground, for the purpose either of driving the tractor over the work zone or of transporting products entering or leaving the farm, a low pressure is harmful, both from the point of view of road handling and of rolling resistance.

In one mode of operation at pressure regulated during use, operation in the fields, at low pressure, will thus alternate with operation on the road, at high pressure. It is known that at high pressure, the contact patch in which the tire is in contact with the ground is rather narrow and the load is reacted essentially by the centre of the tread, whereas at low pressure, the contact patch in which the tire is in contact with the ground is wide and the load is reacted essentially by the edges of the tread or shoulder. There is thus an alternation between:

use on the road at high pressure, loading the centre of the tread on non-aggressive ground of the road type, for which the essential performance expected of the rubber in contact with the ground is wear resistance,

use in the fields at low pressure, loading the outside of the tread on ground of the loose type which is potentially aggressive, on account of the presence of rocks or stones, for which the essential performance expected of the rubber in contact with the ground is resistance to mechanical attack.

The inventors have set themselves the objective of improving the compromise between the wear resistance, at the centre of the tread, in the event of use on roads, and the resistance to mechanical attack, at the shoulders of the tread, in the event of use in the fields.

This objective has been achieved according to the invention by a tire for an agricultural vehicle, comprising:

a tread that is intended to come into contact with the ground and has an axial width L measured between two axial ends,

the tread comprising lugs that are separated from one another by grooves,

each lug extending radially outwards, over a radial height H, from a bottom surface as far as a contact face,

the grooves consisting of the portions of the bottom surface separating the lugs,

the tread comprising a first, median portion having an axial width L₁, at least equal to 0.25 times and at most equal to 0.75 times the axial width L, and second and third, lateral portions that respectively extend axially outwards from the first, median portion as far as an axial end and have respective axial widths (L₂, L₃),

each lug portion that is axially contained in the first, median portion and extends radially inwards, from the contact face as far as a first interface, over a radial distance D₁ at least equal to 0.5 times and at most equal to 1 time the radial lug height H, consisting of a first elastomeric compound,

and each lug portion that is axially contained in one of the second or third, lateral portions and extends radially inwards, from the contact face as far as a second interface, over a radial distance D₂ at least equal to 0.5 times and at most equal to 1 time the radial lug height H, consisting of a second elastomeric compound.

The invention aims to obtain differentiation in the performance of the tread between a first, median portion that consists at least partly of a first elastomeric compound and is intended to resist wear when used on the road, and second and third, lateral portions that consist at least partly of a second elastomeric compound and are intended to resist attack when used in the fields. Consequently, the first and second elastomeric compounds are essentially different.

The first, median portion is a tread portion that extends axially on either side of the equatorial plane of the tire and, usually but not exclusively, is symmetrical with respect to the equatorial plane of the tire. The second and third, lateral portions are tread portions that extend axially on either side of the first, median portion from the first, median portion as far as an axial end of the tread.

According to the invention, with the tread being defined geometrically by its axial width L, which is the axial distance between its two axial ends, the first, median portion has an axial width L₁ at least equal to 0.25 times and at most equal to 0.75 times the total axial width L of the tread. In the most frequent case of a first, median portion that is symmetrical with respect to the equatorial plane of the tire, the respective axial widths L₂ and L₃ of the second and third, lateral portions are the same as one another and are at least equal to 0.125 times and at most equal to 0.375 times the total axial width L of the tread.

Also according to the invention, each lug portion that is axially contained in the first, median portion and extends radially inwards, from the contact face as far as a first interface, over a radial distance D₁ at least equal to 0.5 times and at most equal to 1 time the radial lug height H, consists of a first elastomeric compound. The radial lug height H is measured on the tire when it is new, that is to say not worn. The first elastomeric compound extends radially over the above-defined radial distance D₁ and axially from a first axial end of the median portion as far as a second axial end of the median portion.

Since the first, median portion is the tread portion that is mainly subjected to wear, when used on the road, all of the lug portions that are axially positioned in this first, median portion, advantageously consist of a first, wear-resistant elastomeric compound. Moreover, the inventors have shown that, in the radial direction, a lug portion of which the radial height is between 0.5 times and 1 time the radial lug height H, that is to say represents 50% to 100% of the radial lug height H, starting from the contact face, and consists of such a first elastomeric compound, makes a significant contribution to the wear performance when used on the road.

Likewise according to the invention, each lug portion that is axially contained in one of the second or third, lateral portions and extends radially inwards, from the contact face as far as a second, over a radial distance D₂ at least equal to 0.5 times and at most equal to 1 time the radial lug height H, consists of a second elastomeric compound. The radial lug height H is measured on the tire when it is new, that is to say not worn. The second elastomeric compound extends radially over the above-defined radial distance D₂ and axially from a first axial end of each lateral portion as far as a second axial end of said lateral portion.

Since the second and third, lateral portions are the tread portions that are mainly subjected to attack when used in the fields, all of the lug portions that are axially positioned in one of the second or third, lateral portions advantageously consist of a second, attack-resistant elastomeric compound. Moreover, the inventors have shown that, in the radial direction, a lug portion of which the radial height is between 0.5 times and 1 time the radial lug height H, that is to say represents 50% to 100% of the radial lug height H, starting from the contact face, and consists of such a second elastomeric compound, makes a significant contribution to the resistance to attack when used in the fields.

It should be noted that the radial height of a lug portion that is axially positioned in one of the second or third, lateral portions and consists of the second elastomeric compound is not necessarily equal to the radial height of a lug portion that is axially positioned in the first, lateral median portion and consists of the first elastomeric compound.

According to a first advantageous embodiment, each lug portion that is axially contained in the first, median portion and extends radially inwards, from the first interface as far as a third interface positioned radially inside the bottom surface at a radial distance D₃ at least equal to 3 mm, consists of the first elastomeric compound.

In other words, the first elastomeric compound extends radially inwards, from the contact face of any lug portion that is axially positioned in the first, median portion, not just over the entire radial lug height H but also over a tire portion that extends radially inwards, from the bottom surface as far as a third interface positioned radially inside the bottom surface at a distance D₃ at least equal to 3 mm. The tire portion contained between the bottom surface and the third interface is usually known as the void rubber. Its role is to protect the crown reinforcement of the tire radially on the inside of the tread from mechanical and physicochemical attack. The radial distance between the bottom surface and the third interface defines the thickness of the void rubber, which is an important feature in protecting the crown reinforcement of the tire. A minimum void rubber thickness ensures the wear resistance in the first, median portion until the lugs have completely worn away, or even beyond, that is to say when the void rubber is itself partially worn.

According to a second advantageous embodiment, each lug portion that is axially contained in one of the second or third, lateral portions and extends radially inwards, from the second interface as far as a third interface positioned radially inside the bottom surface (5) radial distance D₃ at least equal to 3 mm, consists of the second elastomeric compound.

In other words, the second elastomeric compound extends radially inwards, from the contact face of any lug portion that is axially positioned in one of the second or third, lateral portions, not just over the entire radial lug height H but also over the tire void rubber that extends radially inwards, from the bottom surface as far as a third interface positioned radially inside the bottom surface at a distance D₃ at least equal to 3 mm. A minimum void rubber thickness ensures the resistance to attack in the second and third, lateral portions until the lugs have completely worn away, or even beyond, that is to say when the void rubber is itself partially worn.

Advantageously, the radial distance D₃ between the bottom surface and the second interface is at most equal to 15 mm. In other words, the void rubber thickness has an upper limit equal to 15 mm, corresponding to the maximum thickness above which the level of heat in the crown becomes too great. This upper limit thus ensures satisfactory endurance of the crown from the thermal point of view.

Usually, the radial distance D₁ between the contact face and the first interface, and the radial distance D₂ between the contact face and the second interface are the same. In other words, the radial height of a lug portion that is axially positioned in the first, lateral median portion and consists of the first elastomeric compound is equal to the radial height of a lug portion that is axially positioned in one of the second or third, lateral portions and consists of the second elastomeric compound.

Likewise advantageously, with the first elastomeric compound having a complex dynamic shear modulus G₁* at 50% deformation and 60° C., the complex dynamic shear modulus G₁* of the first elastomeric compound is at least equal to 1.4 MPa and preferably at most equal to 2 MPa. A complex dynamic shear modulus G₁* at 50% deformation and 60° C. lying within such a range of values gives the first elastomeric compound cohesion properties that are favourable for limiting wear when used on the road.

Also advantageously, with the first elastomeric compound having a loss factor tan (δ₁) at 60° C., the loss factor tan (δ₁) of the first elastomeric compound is at least equal to 0.22 and at most equal to 0.30. A loss factor tan (δ₁) lying in such a range of values makes it possible to limit the dissipation of energy and thus the level of heat.

Generally, the complex modulus G* and the loss factor tan (δ) of an elastomeric compound are properties known as dynamic properties. They are measured on a viscoanalyser known by the name “Metravib VA4000”, according to Standard ASTM D5992-96. The response of a sample of the vulcanized elastomeric compound, in the form of a cylindrical test specimen 4 mm thick and 400 mm² in cross section, subjected to simple alternating sinusoidal shear loading at a frequency of 10 Hz, at a given temperature, for example of 60° C., is recorded. An outward cycle sweeps through amplitudes of deformation from 0.1% to 50%, then a return cycle sweeps from 50% to 1%. The results exploited are in particular the complex dynamic shear modulus G* and the loss factor tan (δ). For the return cycle, the maximum observed value of tan (δ) is indicated, and this is denoted tan (δ)ₘₐₓ.

From the point of view of the chemical composition, the first elastomeric compound that at least partially makes up the lug portions of the first, median portion comprises diene elastomers, reinforcing fillers and a crosslinking system. The diene elastomers conventionally used are selected from the group consisting of polybutadienes (BR), natural rubber (NR), synthetic polyisoprenes (PI) and stirene butadiene copolymers (SBR). Preferably, the elastomers are used in the form of NR/BR or SBR/BR blends, or even NR/BR/SBR blends. Preferably, the SBRs used have dynamic glass transition temperatures or Tg values below −45° C., measured on a viscoanalyser known by the name “Metravib VA4000”, according to Standard ASTM D 5992-96. As far as the reinforcing filler is concerned, the first elastomeric compound comprises at least a carbon black, such as a carbon black from the 200 and 100 series (ASTM grades), this black having a BET specific surface area greater than 100 m²/g and being used at a rate of between 50 and 75 phr.

The first elastomeric compound, comprising the elastomers or elastomer blends and the carbon blacks mentioned above, has satisfactory properties in terms of resistance to wear when used on the road.

Advantageously, with the second elastomeric compound having a complex dynamic shear modulus G₂* at 50% deformation and 60° C., the complex dynamic shear modulus G₂* of the second elastomeric compound is at least equal to 1.3 MPa- and preferably at most equal to 1.9 MPa. A complex dynamic shear modulus G₂* at 50% deformation and 60° C. of the second elastomeric compound lying within a range of values gives the second elastomeric compound levels of stiffness favourable to resistance to attack when used in the fields.

Also advantageously, with the second elastomeric compound having a loss factor tan (δ₂) at 60° C., the loss factor tan (δ₂) of the second elastomeric compound is at least equal to 0.24 and at most equal to 0.32. A loss factor tan (δ₂) lying in such a range of values makes it possible to limit the dissipation of energy and thus the level of heat.

From the point of view of the chemical composition, the second elastomeric compound that at least partly makes up the lug portions of the second and third, lateral portions comprises diene elastomers, reinforcing fillers and a crosslinking system. The diene elastomers conventionally used are preferably selected from the group consisting of natural rubber (NR), synthetic polyisoprenes (PI) and stirene butadiene copolymers (SBR). Preferably, the elastomers are used in the form of NR/SBR or SBR/SBR blends. Preferably, the SBRs used alone or in blends have dynamic glass transition temperatures or Tg values of between −50° C. and −20° C., measured on a viscoanalyser known by the name “Metravib VA4000”, according to Standard ASTM D 5992-96. As far as the reinforcing filler is concerned, the second elastomeric compound comprises at least a carbon black, such as a carbon black from the 300, 200 and 100 series (ASTM grades), this black having a BET specific surface area of less than 80 m²/g and being used at a rate of between 50 and 75 phr.

As far as industrial workability is concerned, a tire according to the invention and, more specifically, the tread of such a tire, can be manufactured according to a method as described and claimed in document WO 2009131578. The invention described and claimed in document WO 2009131578 relates to methods and to a device for forming a multilayer tire compound, the steps of the method involving:

using a mechanical system, the system comprising a plurality of cutting elements;

moving a sheet of material along a path through the mechanical system;

cutting a first strip from the sheet using one or more elements of the plurality of cutting elements, this step taking place during the movement step;

mechanically applying the first strip to a building surface, this step taking place during the movement step;

cutting a second strip from the sheet after the step of cutting the first strip, this step taking place during the movement step;

mechanically applying the second strip to a building surface, this step taking place during the movement step.

Specific embodiments of the method described above, relating to a multilayer manufacture of the tread, have also been described in documents WO 2013176675 and WO 2013176676.

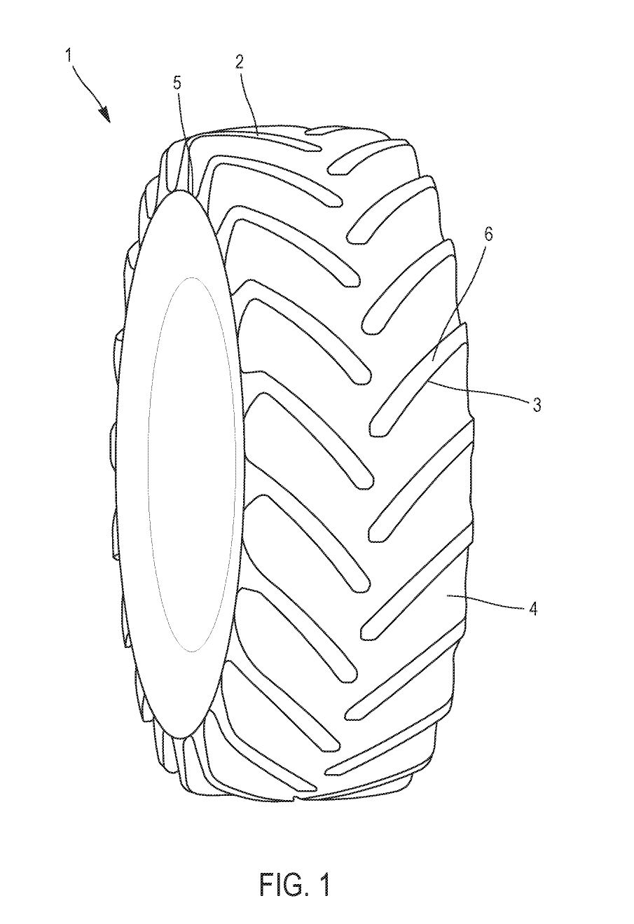

The present invention will be better understood with the aid of the appended FIGS. 1 to 3 which are schematic and not drawn to scale:

FIG. 1: a perspective view of a tire for an agricultural vehicle,

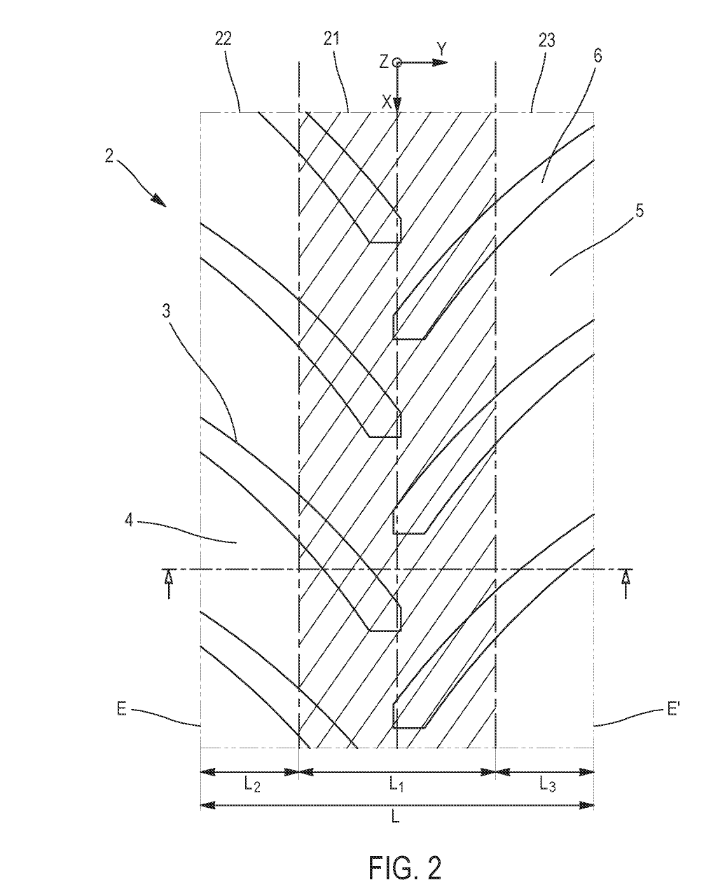

FIG. 2: a view in a radial direction (Z) of the tread of a tire for an agricultural vehicle,

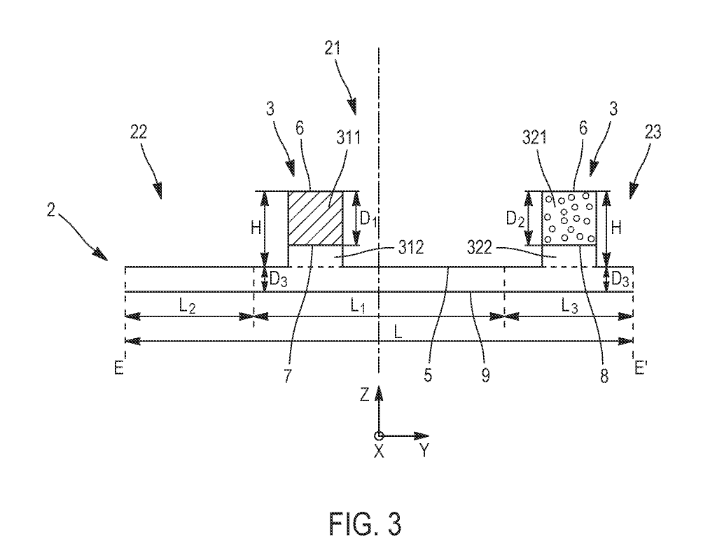

FIG. 3: a view in section on a meridian plane (YZ) of a portion of tread of a tire according to the invention.

FIGS. 1 and 2 respectively show a perspective view of a tire 1 for an agricultural vehicle, and a view, in a radial direction Z, of the tread of such a tire. The tread 2, intended to come into contact with the ground via a tread surface, comprises lugs 3 separated from one another by grooves 4. Each lug 3 extends radially outwards, from a bottom surface 5 as far as a contact face 6 positioned in the tread surface. The grooves 4 consist of the portions of the bottom surface 5 that separate the lugs 3.

In FIG. 2, the tread 2 has an axial width L measured between two axial ends (E, E′). It comprises a first, median portion 21 (hatched) having an axial width L₁, at least equal to 0.25 times and at most equal to 0.75 times the axial width L, and second and third, lateral portions (22, 23) that respectively extend axially outwards from the first, median portion 21 as far as an axial end (E, E′) and have respective axial widths (L₂, L₃). In the case shown, the axial width L₁ of the median portion 21 of the tread 2 is equal to 0.5 times the axial width L of the tread, and the respective axial widths (L₂, L₃) of the second and third, lateral portions are the same as one another and respectively equal to 0.25 times the axial width L of the tread 2. In accordance with the invention, the lug portions 3 that are axially positioned in the first, median portion 21 consist, over at least a part of their radial height H, of a first elastomeric compound, while the lug portions 3 that are axially positioned in one of the second or third, lateral portions (22, 23) consist, over at least a part of their radial height H, of a second elastomeric compound.

FIG. 3 shows a view in section on a meridian plane (YZ) of the tread 2 of a tire according to a particular embodiment of the invention. The tread 2, having an axial width L measured between two axial ends (E, E′), comprises a first, median portion 21 having an axial width L₁ equal, in the case shown, to 0.5 times the axial width L, and second and third, lateral portions (22, 23) that respectively extend axially outwards from the first median portion 21 as far as an axial end (E, E′) and have respective axial widths (L₂, L₃) that are the same as one another and are respectively equal to 0.25 times the axial width L. In the first, median portion 21, a lug portion 311 consisting of a first elastomeric compound (hatched) that is resistant to wear when used on the road extends radially inwards from the contact face 6 as far as a first interface 7, over a radial distance D₁ at least equal to 0.5 times and at most equal to 1 time the radial lug height H. In the third, lateral portion 23, a lug portion 321 consisting of a second elastomeric compound (dotted) that is resistant to attack when used in the fields extends radially inwards from the contact face 6 as far as a second interface 8, over a radial distance D₂ at least equal to 0.5 times and at most equal to 1 time the radial lug height H. The tire portion contained between the bottom surface 5 and a third interface 9, radially inside the bottom surface 5 at a radial distance D₃, forms the void rubber. In the case shown, a third elastomeric compound, different from the first and second elastomeric compounds, extends radially inwards from the first and second interfaces (7, 8) as far as the third interface 9.

The invention has been studied in more particular detail for an agricultural tire in which the first elastomeric compound has a complex dynamic shear modulus G₁* equal to 1.72 MPa and a loss factor tan (δ₁) equal to 0.30, and the second elastomeric compound has a complex dynamic shear modulus G₂* equal to 1.47 MPa and a loss factor tan (32) equal to 0.32.

The first and second elastomeric compounds may have chemical compositions that differ from those described above, depending on the performance sought for the tire.

The invention is applicable, more generally, to any tire the tread of which comprises raised elements and which is likely to run over ground comprising aggressive indenting features, such as a construction plant vehicle tire.

1. A fire for an agricultural vehicle, comprising:
a tread that is intended to come into contact with the ground and has an axial width L measured between two axial ends;
the tread comprising lugs that are separated from one another by grooves;
each lug extending radially outwards, over a radial height H, from a bottom surface as far as a contact face;
wherein the grooves include the portions of the bottom surface separating the lugs;
wherein the tread comprises a first, median portion having an axial width L₁ at least equal to 0.25 times and at most equal to 0.75 times the axial width L, and second and third, lateral portions that respectively extend axially outwards from the first, median portion as far as said axial ends and have respective axial widths, wherein each lug portion that is axially contained in the first, median portion and extends radially inwards, from the contact face as far as a first interface, over a radial distance D₁ at least equal to 0.5 times and at most equal to 1 time the radial lug height H, comprises a first elastomeric compound, and wherein each lug portion that is axially contained in one of the second or third, lateral portions and extends radially inwards, from the contact face as far as a second interface, over a radial distance D₂ at least equal to 0.5 times and at most equal to 1 time the radial lug height H, consists of comprises a second elastomeric compound.

2. The tire according to claim 1, wherein each said lug portion that is axially contained in the first, median portion and extends radially inwards, from the first interface as far as a third interface positioned radially inside the bottom surface at a radial distance D₃ at least equal to 3 mm, comprises the first elastomeric compound.

3. The tire according to claim 1, wherein each lug portion that is axially contained in one of the second or third, lateral portions and extends radially inwards, from the second interface as far as a third interface positioned radially inside the bottom surface at a radial distance D₃ at least equal to 3 mm, comprises the second elastomeric compound.

4. The tire according to claim 2, wherein the radial distance D₃ between the bottom surface and the third interface is at most equal to 15 mm.

5. The tire according to claim 1, wherein the radial distance D₁ between the contact face and the first interface, and the radial distance D₂ between the contact face and the second interface are the same.

6. The tire according to claim 1, the first elastomeric compound having a complex dynamic shear modulus G₁* at 50% deformation and 60° C., wherein the complex dynamic shear modulus G₁* of the first elastomeric compound is at least equal to 1.4 MPa and at most equal to 2 MPa.

7. The tire according to claim 1, the first elastomeric compound having a loss factor tan (δ₁) at 60° C., wherein the loss factor tan (δ₁) of the first elastomeric compound is at least equal to 0.22 and at most equal to 0.30.

8. The tire according to claim 1, the second elastomeric compound having a complex dynamic shear modulus G₂* at 50% deformation and 60° C., wherein the complex dynamic shear modulus G₂* of the second elastomeric compound is at least equal to 1.3 MPa and at most equal to 1.9 MPa.

9. The tire according to claim 1, the second elastomeric compound having a loss factor tan (δ₂) at 60° C., wherein the loss factor tan (δ₂) of the second elastomeric compound is at least equal to 0.24 and at most equal to 0.32.
